(19) United States
(12) Patent Application Publication
(10) Pub. No.: US 2014/0229386 A1
(43) Pub. Date: Aug. 14, 2014

(54) SECURE MOBILE PAYMENTS

(71) Applicant: Mistral Mobile, San Francisco, CA (US)

(72) Inventors: Timo P. Tervo, San Francisco, CA (US); Nicolas Aubry, San Francisco, CA (US)

(73) Assignee: Mistral Mobile, San Francisco, CA (US)

(21) Appl. No.: 13/958,294

(22) Filed: Aug. 2, 2013

Related U.S. Application Data
(60) Provisional application No. 61/764,203, filed on Feb. 13, 2013.

(51) Int. Cl. G06Q 20/38

(52) U.S. Cl. CPC G06Q 20/3829
USPC 705/71

(57) ABSTRACT

Methods and apparatus, including computer program products, are provided secure payments. In one aspect there is provided a method. The method may include selecting a plurality of key parts from a plurality of key parts collections, wherein the plurality of key parts comprise key parts values and indexes; and generating a message comprising a header and a payload, wherein the header comprises an indicator of the key parts selected from the plurality of key parts collections, and wherein the payload comprises information encrypted using a symmetric key formed by combining the key parts values selected from the plurality of key parts collections. Related apparatus, systems, methods, and articles are also described.

### CROSS-REFERENCE TO RELATED APPLICATIONS

This application claims the benefit of U.S. Provisional Patent Application Ser. No. 61/764,203, filed on Feb. 13, 2013, and entitled “SECURE MOBILE PAYMENTS,” which is incorporated by reference herein in its entirety.

### FIELD

The subject matter described herein relates to wireless communications.

### BACKGROUND

When transactions are executed between a mobile wireless device and a another processor, such as a financial payment processor and/or the like, having a security requirement, the transactions may implement a high-level security model requiring that the transaction be encrypted and/or that the encryption keys for the transaction not be compromised.

In a transaction framework where data connectivity is not limited and where data plans are common, financial transaction messages between a mobile client application at the mobile wireless device and the other processor/financial payment processor can be encrypted using asymmetric encryption, such as for example, RSA, combined with symmetric encryption, such as for example Advanced Encryption Standard (AES). In this security model, the symmetric key is encrypted using the asymmetric public key, and the message or transaction itself is encrypted using the symmetric key.

However, in a framework where connectivity is limited, such as in the case where transactions utilize short message service (SMS) communications or other similar communication channels, the interaction between the mobile client application and the other processor/financial payment processor needs to be optimized as a function of the payload size (for example, in SMS the payload size is targeted to a specific port of the mobile wireless device imposing a maximum limit of 133 bytes). This size limitation makes the above-noted combined asymmetric-symmetric encryption model at the very least impractical to use. To illustrate further, the mere encryption of the symmetric key using RSA at, for example, 1024 bits consumes 128 bytes out of the 133 bytes available in an SMS message—leaving thus very little, only 5 bytes, for the actual payload of the transaction message itself.

To address the above shortcomings of the asymmetric-symmetric encryption model, one approach is to use only asymmetric encryption to encrypt directly the transaction message with an asymmetric public key whose matching private key is available on a server. However, this approach is very limited with respect to flexibility and security. For example, consider that encrypting a message content using a 128-byte RSA public key with recommended Optimal Asymmetric Encryption Padding (OAEP) implies that the amount of usable space for the message content is limited to one block of 128 bytes (i.e., the message content length cannot be longer than the encryption block size). Among the usable 128 bytes, 42 bytes are used by the padding overhead, which yields a message content length that cannot exceed 86 bytes. Moreover, although asymmetric encryption, such as RSA 1024 (which uses a 128 byte key), is valid and often recommended for securing a onetime use symmetric key, RSA 1024 is typically not recommended for encrypting the message content itself as it is slower and less flexible (for example, a message size of 10 bytes would still result in a full 128 encrypted block). Instead, it is typically recommended that the message content be encrypted using symmetric encryption.

Another approach that addresses the above-noted shortcomings of the asymmetric-symmetric encryption model is to use only symmetric encryption to encrypt the transaction message using a symmetric key commonly known by the client and the server. Symmetric encryption, such as AES, can be used to provide sufficient security with minimal overhead. Although considered a viable approach by some for message encryption, this symmetric approach still has shortcomings. For example, using symmetric encryption implies that the same symmetric key is known and shared by both endpoints of the system, such as the mobile wireless device and the other processor/financial payment processor. However, frequently, shared keys between the endpoints create security vulnerabilities, such as a malicious entity intercepting a message containing a symmetric key. Moreover, shared keys may present key distribution challenges within the limited connectivity SMS channels. And although new keys may be distributed less frequently and reused, this can increase the likelihood of a malicious entity secretly intercepting the encrypted message and then decoding the message.

### SUMMARY

Methods and apparatus, including computer program products, are provided for secure payment processing.

In one aspect there is provided a method. The method may include selecting a plurality of key parts from a plurality of key parts collections, wherein the plurality of key parts comprise key values and indexes; and generating a message comprising a header and a payload, wherein the header comprises an indicator of the key parts selected from the plurality of key collections, and wherein the payload comprises information encrypted using a symmetric key formed by combining the key parts values selected from the plurality of key parts collections.

In some variations, one or more of the featured disclosed herein including one or more of the following features can optionally be included in any feasible combination. The plurality of key parts collections may comprise 4 key parts collections, wherein each of the 4 key parts collections may comprise 16 key parts, and wherein each key part may comprise an index and a value. The indicator may comprise the indexes from the selected key parts. The indicator may be generated, and the indicator may comprise a combination of the indexes of the key parts values selected from the plurality of key parts collections. The combination may comprise a sequence defined by the plurality of key parts collections. The plurality of key parts collections may be received. The generated message may be sent to a server. The symmetric key may comprise a one-time key unique to a transmission of the message. The information may represent a financial transaction. The symmetric key may be generated dynamically by at least the selecting of the plurality of key parts, when the information representative of the financial transaction is received. The payload may be encrypted using the symmetric key, the payload including the information encrypted. The generated message may be received. A recomposed symmetric key may be generated based on the header. And, the payload portion of the received message may be decrypted using the recomposed symmetric key. The selecting and the generating may be performed by at least one of a user equipment including a mobile payment application and a server.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example process for encrypting messages, in accordance with some example embodiments;

FIG. 2 depicts examples of key collections, key parts, symmetric keys, messages, and/or the like, in accordance with some example embodiments;

FIG. 3 depicts an example system block diagram, in accordance with some example embodiments;

FIG. 4 depicts another example system block diagram, in accordance with some example embodiments;

FIG. 5 depicts another example process for encrypting messages, in accordance with some example embodiments; and

FIG. 6 depicts an example block diagram of a radio, in accordance with some example embodiments.

Like labels are used to refer to same or similar items in the drawings.

### DETAILED DESCRIPTION

In some exemplary embodiments, a mobile application may receive one or more key parts collections including a plurality of key parts. These key parts may include key values and indexes. A key value represents a portion of a symmetric key, and an associated index identifies the key value in a certain key collection. For example, when information is prepared and ready for secure transmission by the mobile application, the mobile application may select 2 key parts (i.e., key values and corresponding indexes) from each of the 4 key parts collections, although other quantities of key values and key collections may be used as well. The mobile application may then combine the selected key values to form a symmetric key, which is then used to encrypt the prepared and ready to transmit information. The mobile application may then generate a short message service (SMS) message carrying at least a header portion and a payload portion. The payload may include the encrypted information, and the header may contain the indexes identifying which key parts values were selected to form the symmetric key. The mobile application may then send the SMS message to a server, where the SMS message is decrypted. In some example embodiments, the symmetric key is dynamically generated in the sense that each piece of information, such as financial transaction information, requiring transmission to the server is encrypted with a unique, one-time key. Moreover, the key parts collections at the mobile application may be updated with another collection of key parts, when the possible key combinations have been exhausted, when the keys have been compromised, and/or any other time new key collections are desired. The subject matter disclosed herein may, in some example implementations, provide symmetric encryption for SMS communication and the like using a dynamic, one-time use symmetric key formed from key parts values shared by the sender and receiver.

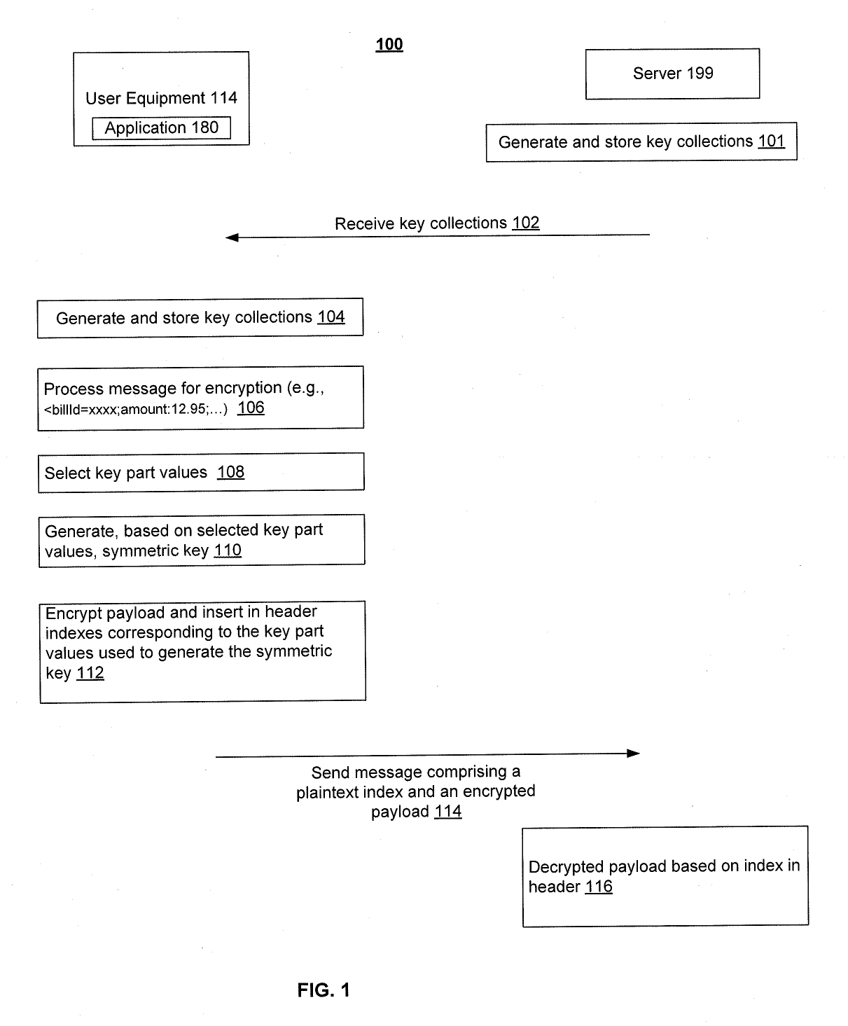

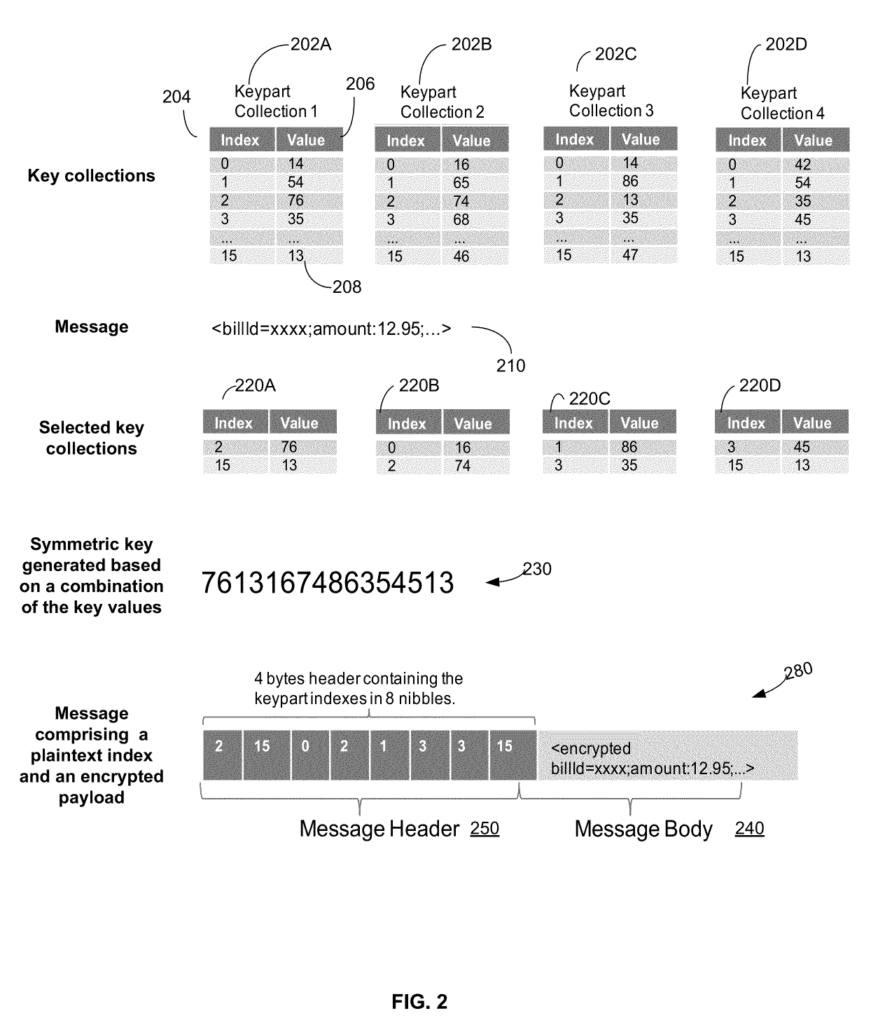

FIG. 1 depicts an example process 100 for providing secure transactions, in accordance with some example embodiments. The description of FIG. 1 also refers to FIG. 2.

In some exemplary embodiments, user equipment 114 may be implemented as a mobile wireless device. The user equipment 114 may be referred to as, for example, a mobile station, a mobile unit, a subscriber station, a wireless terminal, a tablet, a smart phone, a cell phone, and/or the like. The user equipment may be implemented as, for example, a wireless handheld device, a wireless plug-in accessory, and/or the like. In some cases, the user equipment may include a data processor, a computer-readable storage medium (e.g., memory, storage, and/or the like), a radio access mechanism, and/or a user interface. Moreover, the user equipment may include one or more client applications, such as a mobile payment application 180 (labeled application) stored as code in memory and executable by a data processor. Mobile payment application 180 may provide a service that provides secure payment over SMS as disclosed herein. Furthermore, user equipment 114 may be configured to send SMS messages to a wireless access point, such as a base station, a WiFi access point, and/or the like, interfaced to the public land mobile network.

Server 199 may include a data processor and a computer-readable storage medium (e.g., memory, storage, and/or the like). In some example embodiments, server 199 may be implemented as a gateway having a first interface to a SMS aggregator (and/or SMS provider) and a second interface to a financial payment processor associated with for example a system processing a bill payment, an electronic payment, a purchase, mobile money, a mobile money transfer, a mobile wallet, adding funds or topping off an electronic funds account, a loan request, a loan pay back, account management, an insurance claim, and/or the like. Although some of the examples disclosed herein refer to securing payments and financial transactions, the security mechanisms disclosed herein may be used in other environments and systems as well.

At 102, the server 199 may generate and store key parts collections. For example, server 199 may comprise a data processing device configured to generate key parts collections. Specifically, server 199 may randomly generate and store key parts collections, each of which includes indexes and corresponding key parts values. The key parts values represent portions of a symmetric key, and when some of these portions are combined, the combined portions form a symmetric key used to encrypt information using a symmetric encryption engine, such as AES and/or the like. In some example embodiments, server 199 includes a security module that generates, or receives from a random or key generator, 4 key parts collections, as depicted at FIG. 2 (although other quantities may be used as well). These key parts collections may then be securely stored at server 199.

The example of FIG. 2 depicts 4 key parts collections 202A-D, and the key parts collections include indexes 204 and key parts values 206. Each of the indexes uniquely maps, and thus identifies, a certain key part value. In some example embodiments, each of the key parts collections includes 16 key parts, each comprising an index and a key part value. For example, these 16 key parts at key parts collection 202A comprise index 0 and key value 14, index 1 and key value 54, index 2 and key value 54, and so forth through index 15 and corresponding key value 13. Moreover, any key part value can be identified uniquely based on its collection and index. For example, key part value 13 (at 208) can be uniquely identified by specifying the key part collection and index, which in this example is key part collection 1 and index 15 (e.g. 1, 15). In any case, the key parts values can be combined by, for example, concatenating the key parts values to form a symmetric key as further described below. In some example embodiments, additional layers of security may be provided so long both endpoints are aware of those additional layers to enable processing. For example, key parts values may be built in other ways from the shared key part collection and index information so long as both endpoints are aware of the way being used.

Referring again to FIG. 1 at 102, once the key parts collections are generated, server 199 may store the key parts collections in a secure manner, such as using a dedicated secure storage mechanism including, for example, a hardware security module (HSM).

At 104, the server 199 may send the key parts collections generated and stored at 102 to user equipment 114. For example, server 199 may share the key parts collections 202A-D with user equipment 114 including mobile payment application 180 by sending the key parts collections 202A-D. In some example embodiments, the key parts collections may be sent via at least a wireless link carrying a encrypted SMS message as disclosed herein (e.g., an index and an encrypted payload, using for example AES, as disclosed herein), although the key parts collections may be sent in other ways as well. For example, when the client device, such as user equipment 114, connects to server 199 for the first time, user equipment 114 may obtain the initial key parts collections (and/or other software and/or data for the mobile application 180) via a secure connection using, for example, a symmetric key shared through asymmetric encryption. After that initial key parts collection delivery, the encrypted SMS messages disclosed herein may be used to share the key collections.

Once the user equipment 114 receives the key parts collections, user equipment 114 may then store at 104 the key parts collections. Moreover, the mobile payment application 180 and/or user equipment 114 may receive key parts collections 202A-D and then store the key parts collections 202A-D securely using, for example, local encrypted, or otherwise secure, storage.

At 106, a message may be processed for encryption, in accordance with some example embodiments. For example, mobile payment application 180 and/or user equipment 114 may have a message for transmission, such as a bill pay message (“<billId=xxxx;amount:12.95>”) 210 at FIG. 2. In this example, the message represents a financial transaction to be carried by an SMS message securely, and, in particular, a user of user equipment 114 submitting bill payment to server 199.

At 108, the application 180 at user equipment 114 may select key parts. For example, application 180 may randomly select 2 key parts from each collection, as depicted at 220A-D at FIG. 2.

At 110, a symmetric key may be generated, based on the selected key parts. For example, user equipment 114 and/or application 180 may select the key values from each of the selected key parts 220A-D and then combine those key values to form a symmetric key. Referring again to FIG. 2, the generated key is 7613167486354513 (at 230). This generated key represents the concatenation of the selected key parts values, 76 and 13, from the first collection, the key parts values, 16 and 74, from the second collection, the key parts values, 86 and 35, from the third collection, and the key parts values, 45 and 13, from the fourth collection.

In some example embodiments, the generated symmetric key may also be hashed using user equipment 114's Mobile Station International Subscriber Directory Number (MSISDN), a Bluetooth universally unique identifier (UUID), or any other identifier (which would also be known by the server 199).

At 112, the symmetric key may be used to encrypt the message payload, and a plaintext header including key parts indexes may be appended to the payload. For example, the message payload, “<billId=xxxx;amount:12.95>”, may be encrypted symmetrically using the key generated at 110. The key parts indexes for the selected key parts collections may then be combined and inserted into a header. This header may be in plaintext, i.e., not encrypted by the symmetric key. Referring again to FIG. 2, the message body 240 includes the encrypted payload of “<billId=xxxx;amount:12.95>.” The message header 250 includes the indexes for the selected key parts values contained in the symmetric key, so that the index uniquely indentifies all of the key parts value pieces used to form the entire symmetric key 230. For example, the message header 230 includes indexes 2 and 15 from the first collection 220A, indexes 0 and 2 from the second collection 220B, indexes 1 and 3 from the third collection 220C, and indexes 3 and 15 from the fourth collection 220D. Because the message header 230 includes the ordered indexes from each key parts collection 220A-D, the server 199 will be able to determine symmetric key 230 based on the plaintext index contained in the message header 250. In some example embodiments, the symmetric encryption is AES, although other symmetric encryption techniques may be used as well.

Although the message header 250 at FIG. 2 includes the indexes in a predetermined order corresponding to the collections 202A-D, the indexes may be placed in the header in other orders as well. When this is the case, server 199 may be configured to know the index placement technique used at the user equipment to access the key parts values in the key parts collections.

In some example embodiments, the message body 240 may also be signed using, for example, a hash as noted above. This hash may be implemented as a Secure Hash Algorithm (SHA) and/or MD5, although other hash techniques may be used as well.

In the example of FIG. 2, as symmetric key creation relies on 4 key parts collections from which 2 key parts among 16 are randomly selected, the amount of unique combinations is 262,144 (i.e., 4 times 2¹⁶). Moreover, the header 250 may, in some example embodiments, contains 4 bytes reserved to receive the 8 indexes of the key parts necessary to re-generate the symmetric key for decrypting the message body 240. Each of these indexes fit into one nibble (i.e., a half-byte whose value is between 0-15), so the 8 indexes of the key parts can be set using only 4 bytes (i.e., 8×½ byte). Although some of the examples described herein refer to specific quantities of key parts values, key collections, and indexes, other quantities may be implemented as well.

At 114, the message may be sent to server 199. Referring again to FIG. 2, user equipment 114 may send message 280 including message header 250 and message body 240 to server 199. Moreover, message 280 may be sent via SMS or any other connectivity channel between client and server. Specifically, user equipment 114 may provide message 280 to an SMS interface at the user equipment 114 for sending the message 280 via SMS. The server 199 may have an interface to an SMS provider, which provides the SMS message 280 to server 199. In this example, the server 199 may obtain the user equipment's MSISDN from the SMS service provider and determine the key parts used based on the header 250 carried by the SMS message.

At 116, server 199 may decrypt the message based on the index in the header. For example, server 199 may read the header comprising 2, 15, 0, 2, 1, 3, 3, and 15 and then access the key parts collections to identify the key parts values forming the symmetric key (which in the depicted example is 7613167486354513) used by user equipment 114 to send the message. Using the symmetric key, server 199 may then decrypt the message into plaintext. When hashing is used, the server 199 may hash the symmetric key before decrypting the message.

In some example embodiments, the server 199 may send an acknowledgement message to user equipment 114 to confirm receipt of the message received by server 199 at 114. This acknowledgement may be sent as an SMS message. Moreover, this SMS acknowledgement message may carry a payload encrypted using the same symmetric key used to encrypt the payload of the message received at 114, although a different symmetric key may be generated using the key parts collections.

In some example embodiments, each generated symmetric key is used only during one request/response sequence before it is discarded. When this is the case, the user equipment 114 may store and keep a record of all the used key parts combinations. Moreover, the record may allow server 199 to reject any incoming messages that use an already-used symmetric key. Furthermore, once a certain amount of key parts combinations have been used or when the key parts collections (or portions thereof) have been compromised, server 199 may, in some example embodiments, decide to renew the key parts collections by resending a new set of key parts collections at 102.

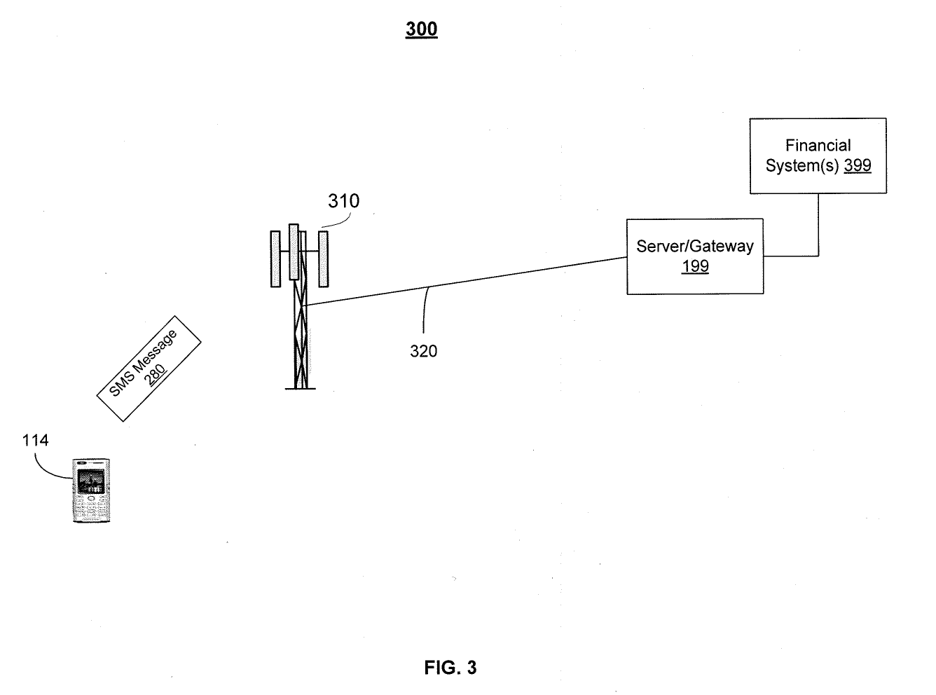

FIG. 3 depicts an example system 300 including user equipment 114, in accordance with some example embodiments. User equipment 114 may send an SMS message, such as for example SMS message 280 as described above with respect to 114, to server 199 via an access point, such as a base station (e.g., a base station of a public land mobile network), a wireless access point (e.g., WiFi access point), and/or any other mechanism capable of handling an SMS message. The access point may include wired and/or wireless backhaul links 320 to other devices, networks, and/or the like, to enable access to server 199. Server 199 may then decrypt the SMS message, as described above at 116, and then provide the payment information securely to system, such as a financial system configured to handle and/or process the payment. For example, the decrypted message may be posted to an account to post the payment represented by the message.

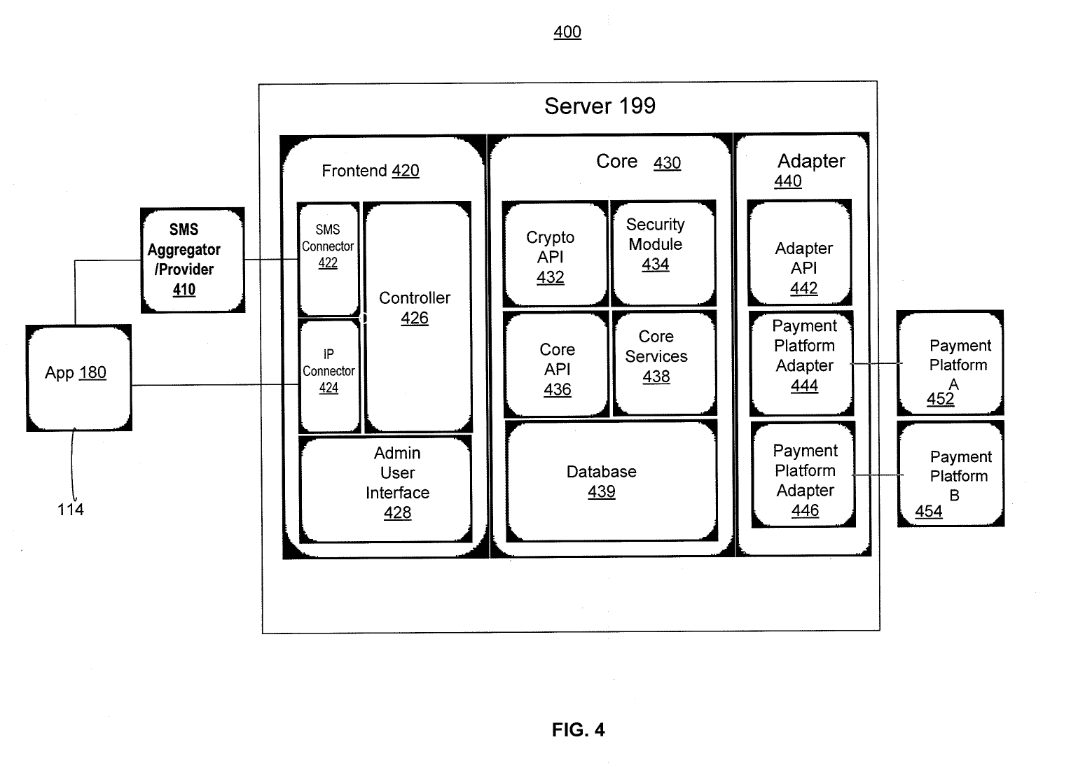

FIG. 4 depicts an example system 400 including user equipment 114 and server 199. User equipment 114 and/or application 180 may send an SMS message as described at 114 to server 199 via at least a wireless network and an SMS aggregator/provider 410. The SMS aggregator/provider 410 provides an interface between server 199 and public land mobile networks (including the SMS communication mechanisms therein). For example, the SMS message sent by user equipment 114 may traverse at least a public land mobile network to SMS aggregator/provider 410, which forwards the SMS message to server 199. In addition, when server 199 sends SMS messages to user equipment 114, those SMS messages traverse the SMS aggregator/provider 410.

The server 199 may include a front-end subsystem 420, a core subsystem 430, and an adapter subsystem 440. The front-end subsystem 420 may further include an SMS connector 422 for interfacing with SMS aggregator/provider 410, an Internet Protocol (IP) connector 424 for handling IP connections to the user equipment 114 (e.g., to carry transactions and/or exchanging key collections as described with respect to SMS channels), a front-end controller 426 for controlling the front end to perform the operations disclosed herein, and an administrative user interface 428 for configuring system settings, connectivity with financial service platform and other use cases for mobile application 180. The core subsystem 430 may include a crypto application-programming interface (API) 432 for accessing security services, such as a hardware or software security module. The core 430 may further include a security module 434 for providing secure services, such as an HSM configured to manage digital keys, accelerate crypto processing accelerator, provide authentication to enable key access, and/or the like. The core 430 may further include a core API 436 for providing access to internal services, a core service module 438 for managing business processes of server 199, and a database 439 for storing the key collections disclosed herein and for other user, transaction, or process related data.

The adaptor 440 may include an adaptor API 442 for integrating third party payment platforms, financial gateway, or any other system of records, and a payment platform adapter 444 configured to provide payment information (extracted from the encrypted SMS messages disclosed herein) to another payment system 452 in a format compatible with payment system 452. In the example of FIG. 4, there is a second adapter 446 interfacing another payment system 454, although other quantities of adapters may be used as well.

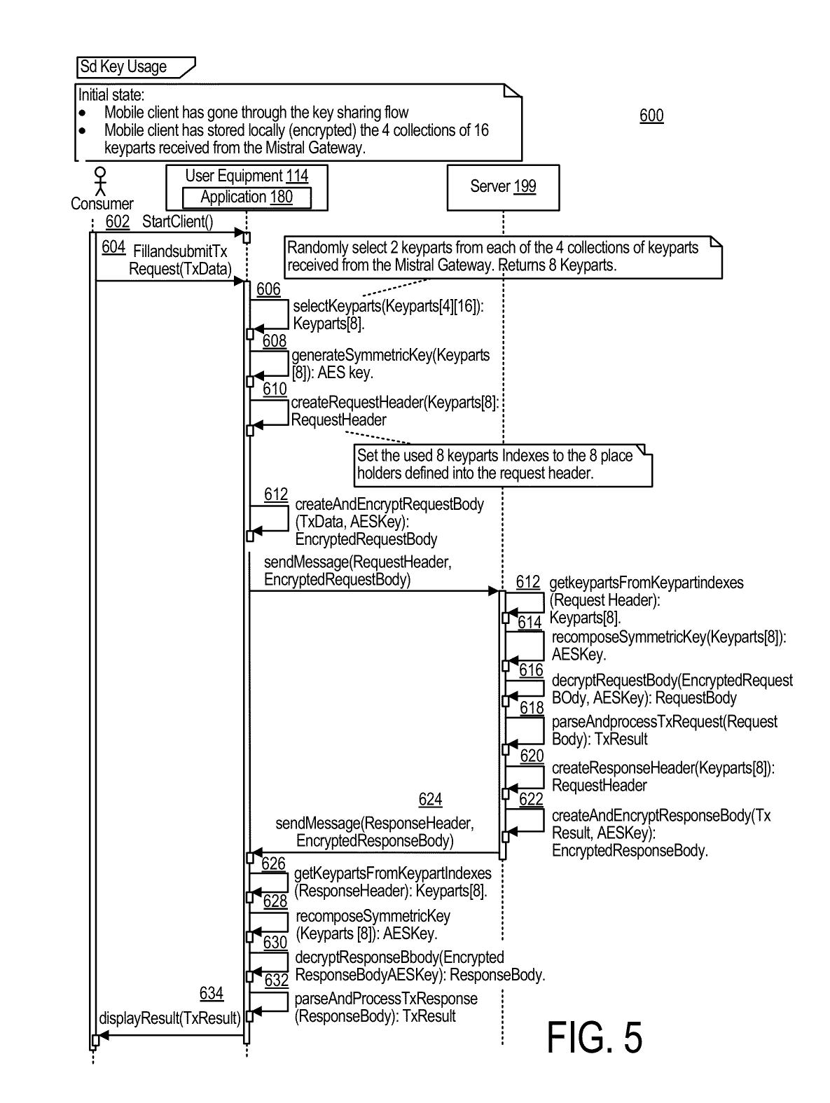

FIG. 5 depicts an example process 600 for sending an SMS message encrypted with a symmetric key composed of key parts as part of a mobile payments process, in accordance with some example embodiments. At 602-604, the mobile payment application 180 may be started and then may receive a transaction request, such as a financial payment message (e.g., message 210 and/or the like). At 606-610, the mobile payment application 180 may then select the key parts from the key parts collections (see, e.g., 220A-D), generate the symmetric key from the selected key parts (see, e.g., 230), create the header from the indexes of the key parts (see, e.g., 250), and create an encrypted message payload/body containing the financial payment message encrypted using the generated symmetric key (see, e.g., 240). At 612, the SMS message (see, e.g., 280) may be sent to server 199. When server 199 receives the SMS message, the server 199 may decrypt the SMS message by at least obtaining at 612 the indexes from the header of the SMS message, re-generating at 614 the symmetric key from the obtained indexes, and at 616 decrypting, using the regenerated key, the payload of the SMS message. At 618, the server 199 may process the decrypted payload and forward information representative of the financial payment message to another system, such as a financial payment system.

At 620-624, the server 199 may generate and send to user equipment 114 an encrypted SMS response message, such as an acknowledgement message, by generating a new unique symmetric key from the key parts collections. At 626-632, the user equipment 114 may decrypt the SMS acknowledgement message by at least obtaining the indexes 626 from the header of the received SMS message, re-generating at 628 the symmetric key from the obtained indexes, and at 630 decrypting, using the regenerated key, the payload of the SMS acknowledgement message. At 632, the server 199 may process the decrypted payload and forward at 634 information representative of the acknowledgement to a user interface for display.

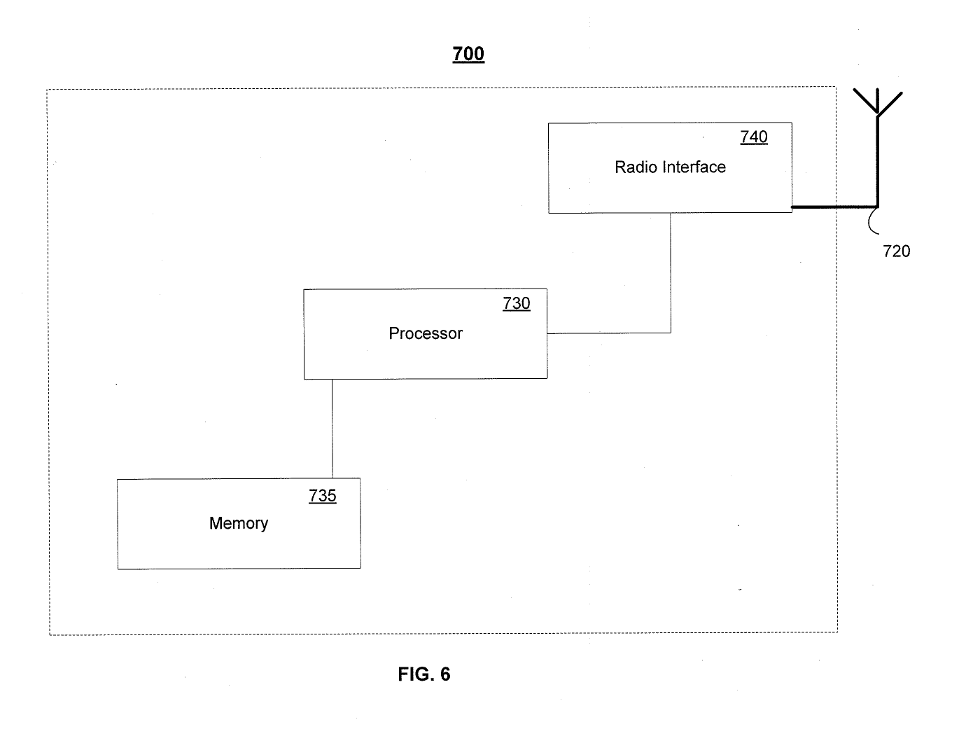

FIG. 6 depicts a block diagram of a radio 700, such as user equipment 114 and the like. The user equipment 114 may include an antenna 720 for receiving a downlink and transmitting via an uplink. The user equipment 114 may also include a radio interface 740, which may include other components, such as filters, converters (e.g., digital-to-analog converters and/or the like), symbol demappers, signal shaping components, an Inverse Fast Fourier Transform (IFFT) module, and/or the like, to process symbols carried by a downlink or an uplink. In some implementations, the user equipment 114 may also be compatible with WiFi, Bluetooth, GERAN, UTRAN, E-UTRAN, first generation (1G) communication protocols, second generation (2G or 2.5G) communication protocols, third-generation (3G) communication protocols, fourth-generation (4G) communication protocols and/or any other standards, radio access technologies, and specifications as well. Moreover, the user equipment 114 may be configured to support messaging, such as SMS messages. The user equipment 114 may further include at least one data processor, such as data processor 730 (e.g., a microprocessor and/or the like) for controlling user equipment 114 and for accessing and executing program code stored in memory 735. For example, memory 735 may include code for performing one or more of the operations associated with the SMS encryption disclosed herein (e.g., process 100, 600, and/or the like).

In some example embodiments, the subject matter disclosed herein may provide strong confidentiality and security for financial transactions that need to occur in a limited data connectivity framework, such as over an SMS channel.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, some of the examples described herein refer to example values for key part collections, key parts, keys, messages, and the like, but these are only illustrative as other values may be used as well. Furthermore, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed:

1. A method comprising:
selecting a plurality of key parts from a plurality of key parts collections, wherein the plurality of key parts comprise key parts values and indexes; and
generating a message comprising a header and a payload, wherein the header comprises an indicator of the key parts selected from the plurality of key parts collections, and wherein the payload comprises information encrypted using a symmetric key formed by combining the key parts values selected from the plurality of key parts collections.

2. The method of claim 1, wherein the plurality of key parts collections comprises 4 key parts collections, wherein each of the 4 key parts collections comprises 16 key parts, wherein the indicator comprises the indexes from the selected key parts, and and wherein each key part comprises an index and a value.

3. The method of claim 1 further comprising:
generating the indicator comprising a combination of the indexes of the key parts values selected from the plurality of key parts collections.

4. The method of claim 3, wherein the combination comprises a sequence defined by the plurality of key parts collections.

5. The method of claim 1 further comprising:
receiving the plurality of key parts collections.

6. The method of claim 1 further comprising:
sending the generated message to a server.

7. The method of claim 1, wherein the symmetric key comprises a one-time key unique to a transmission of the message.

8. The method of claim 7, wherein the information represents a financial transaction.

9. The method of claim 8, wherein the symmetric key is generated dynamically by at least the selecting of the plurality of key parts, when the information representative of the financial transaction is received.

10. The method of claim 9 further comprising:
encrypting, using the symmetric key, the payload including the information.

11. The method of claim 1 further comprising:
receiving the generated message;
generating, based on at least the header, a recomposed symmetric key; and
decrypting, using the recomposed symmetric key, the payload portion of the message.

12. The method of claim 1, wherein the selecting and the generating are performed by at least one of a user equipment including a mobile payment application and a server.

13. An apparatus, comprising:
at least one processor; and
at least one memory including computer program code, the at least one memory and the computer program code configured to, with the at least one processor, cause the apparatus to perform at least the following:
select a plurality of key parts from a plurality of key parts collections, wherein the plurality of key parts comprise key parts values and indexes; and
generate a message comprising a header and a payload, wherein the header comprises an indicator of the key parts values selected from the plurality of key parts collections, and wherein the payload comprises information encrypted using a symmetric key formed by combining the key parts values selected from the plurality of key parts collections.

14. The apparatus of claim 13, wherein the plurality of key parts collections comprises 4 key parts collections, wherein each of the 4 key parts collections comprises 16 key parts, wherein the indicator comprises the indexes from the selected key parts, and wherein each key part comprises an index and a value.

15. The apparatus of claim 13, wherein the apparatus is further configured to at least generate the indicator comprising a combination of the indexes of the key parts values selected from the plurality of key parts collections.

16. The apparatus of claim 15, wherein the combination comprises a sequence defined by the plurality of key parts collections.

17. The apparatus of claim 13, wherein the apparatus is further configured to at least receive the plurality of key parts collections.

18. The apparatus of claim 13, wherein the apparatus is further configured to at least send the generated message to a server.

19. The apparatus of claim 13, wherein the symmetric key constitutes a one-time key unique to a transmission of the message.

20. The apparatus of claim 19, wherein the information represents a financial transaction.

21. The apparatus of claim 20, wherein the symmetric key is generated dynamically by at least the selecting of the plurality of key parts, when the information representative of the financial transaction is received.

22. The apparatus of claim 21, wherein the apparatus is further configured to at least encrypt using the symmetric key, the payload including the information.

23. The apparatus of claim 13 further comprising:
receiving the generated message;
generating, based on at least the header, a recomposed symmetric key; and
decrypting, using the recomposed symmetric key, the payload portion of the message.

24. The apparatus of claim 13, wherein the apparatus comprises at least one of a user equipment including a mobile payment application and a server.

25. An apparatus comprising:
circuitry configured to select a plurality of key parts from a plurality of key parts collections, wherein the plurality of key parts comprise key values and indexes; and
circuitry configured to generate a message comprising a header and a payload, wherein the header comprises an indicator of the key parts selected from the plurality of key parts collections, and wherein the payload comprises information encrypted using a symmetric key formed by combining the key parts values selected from the plurality of key parts collections.

26. An apparatus comprising:
means for selecting a plurality of key parts from a plurality of key parts collections, wherein the plurality of key parts comprise key parts values and indexes; and
means for generating a message comprising a header and a payload, wherein the header comprises an indicator of the key parts selected from the plurality of key parts collections, and wherein the payload comprises information encrypted using a symmetric key formed by combining the key parts values selected from the plurality of key collections.

27. A computer-readable storage medium including code which when executed by at least one processor provides operations comprising:
selecting a plurality of key parts from a plurality of key parts collections, wherein the plurality of key parts comprise key parts values and indexes; and
generating a message comprising a header and a payload, wherein the header comprises an indicator of the key parts selected from the plurality of key collections, and wherein the payload comprises information encrypted using a symmetric key formed by combining the key parts values selected from the plurality of key parts collections.

28. A method comprising:
storing a plurality of key parts collections including a plurality of key parts, wherein the plurality of key parts comprise key parts values and indexes; and
sending, to a user equipment, one or more of the key parts collections to enable the user equipment to encrypt a portion of a message using a symmetric key formed as a combination one or more key parts values.

29. An apparatus, comprising:
at least one processor; and
at least one memory including computer program code, the at least one memory and the computer program code configured to, with the at least one processor, cause the apparatus to perform at least the following:
store a plurality of key parts collections including a plurality of key parts, wherein the plurality of key parts comprise key parts values and indexes; and
send, to a user equipment, one or more of the key parts collections to enable the user equipment to encrypt a portion of a message using a symmetric key formed as a combination one or more key parts values.

30. An apparatus comprising:
circuitry configured to store a plurality of key parts collections including a plurality of key parts, wherein the plurality of key parts comprise key parts values and indexes; and
circuitry configured to send, to a user equipment, one or more of the key parts collections to enable the user equipment to encrypt a portion of a message using a symmetric key formed as a combination one or more key parts values.

31. An apparatus comprising:
means for storing a plurality of key parts collections including a plurality of key parts, wherein the plurality of key parts comprise key parts values and indexes; and
means for sending, to a user equipment, one or more of the key parts collections to enable the user equipment to encrypt a portion of a message using a symmetric key formed as a combination one or more key parts values.

32. A computer-readable storage medium including code which when executed by at least one processor provides operations comprising:
storing a plurality of key parts collections including a plurality of key parts, wherein the plurality of key parts comprise key parts values and indexes; and
sending, to a user equipment, one or more of the key parts collections to enable the user equipment to encrypt a portion of a message using a symmetric key formed as a combination one or more key parts values.
